(19) United States
(12) Patent Application Publication
(10) Pub. No.: US 2025/0256989 A1
(43) Pub. Date: Aug. 14, 2025

(54) OCEAN-FRIENDLY SEAWATER DESALINATION METHOD

(71) Applicant: Labros Hatzilabrou, Portland, OR (US)

(72) Inventor: Labros Hatzilabrou, Portland, OR (US)

(21) Appl. No.: 19/049,476

(22) Filed: Feb. 10, 2025

Related U.S. Application Data
(60) Provisional application No. 63/551,422, filed on Feb. 8, 2024.

(51) Int. Cl. C02F 1/44; C02F 101/10; C02F 103/02; C02F 103/08

(52) U.S. Cl. CPC C02F 1/441; C02F 2101/10; C02F 2103/02; C02F 2103/08

(57) ABSTRACT

The invention is an ocean-friendly desalination method that can increase potable water recovery and requires half the amount of seawater intake. It produces a smaller volume of highly concentrated brine. The method comprises passing seawater through a membrane via the use of osmotic pressure applied by a piston or turbine; circulating the seawater desalination battery where there is a counter-current exchange; passing the seawater through a reverse osmotic system creating a separation of potable water and heavy brine; evaporating said heavy brine from said seawater for recovery of remaining minerals, and returning the lower saline seawater back to the source.

### CROSS REFERENCE TO RELATED APPLICATIONS

This application claims priority to co-pending U.S. Application, Ser. No. 63/551,422, filed on Feb. 8, 2024, which is hereby incorporated by reference for all purposes.

### BACKGROUND

California is currently facing a shortage of clean, safe, affordable water that is limiting community growth and undermining local economies throughout the state. In a future of climate warming and rainfall pattern shifts, this problem will grow not only in California, but other regions around the world. As surface flows dwindle and over drafted aquifers lose storage capacity due to collapse, solutions for new water supplies have nowhere to turn, except to the sea.

Seawater desalination has been widely touted in California as a reliable, drought-resistant water supply. Unfortunately, the technology is expensive to build and energetically costly to operate. For a typical reverse osmosis (RO) desalination facility commonly in use today, roughly 40% of the product water's cost comes from the electricity to run the plant. In the future, electricity may become less reliable, as evidenced by recurring summer brownouts in California. Certainly, costs will be greater. In other words, current designs of seawater desalination plants do not offer economically sustainable solutions, particularly not for disadvantaged communities and especially not when compared to current costs for groundwater and surface water supplies. Nonetheless, several coastal cities along California's 800-mile coast are contemplating desalination as their only choice. Companies offering to construct these plants offer a single one-size-fits-all reverse osmosis technology known for its poor performance of potable recovery from seawater.

Reverse Osmosis (RO) is most effective in recovering potable water from low salinity sources. It has been used extensively in the beverage industry and for purify and recycling wastewater with recoveries often exceeding 80%. But when salt concentrations go above 10 parts per thousand (ppt), RO recovery drops.

Seawater salinities range between 30 to 35 ppt. Potable recoveries of seawater from RO typically range from 40-50%. That means nearly twice as much seawater must be drawn into a plant in order to produce half as much potable product. Impingement/entrainment mortalities of marine life caused by seawater intakes have already caused permitting problems for designs that require open ocean intake pipes. To mitigate this, some facilities are faced with constructing costly subsurface intake wells. These will need replacements over the lifetime of the plant, adding more costs to the design. Another impact on marine life is the large volume of hypersaline brine waste that is commonly discharged back into the sea, usually through sewer outfalls anchored to the seafloor. Because brine is denser than ambient seawater, it settles and spreads out across the bottom. Where it pools, it creates anoxic dead zones. In some regions along California's coast, valuable fishery species, such as Market squid, ling cod, and Dungeness crabs, make use of seafloor habitats. Market squid, for example, uses the seafloor as a nursery for their eggs. Brine can damage the nurseries and potentially impact the squid fishery. Squid are also a main prey source for sea lions, which are a protected species under the Marine Mammal Protection Act. Brine from desalination facilities could impose unintended costs not only to coastal fishing communities but to protected marine mammals, thereby negating some of the technology's touted benefits.

In short, poor water recoveries from plant utilizing RO technology leads to high energy costs and a potential of environmental harm to the marine environment. Poor recoveries also question claims that these plants will actually provide a reliable long term water supply if the power to run them becomes prohibitive. Thus, there is a need in the art to provide desalinization plants that are more efficient and have reduced environmental impact.

The invention is an ocean-friendly desalination design that can increase potable water recovery to 80%, requires half the amount of seawater intake, and produces a smaller volume of a highly concentrated brine that is more easily processed as a secondary salt product for sale to offset plant costs. The disclosed design also recovers energy as seawater passes through a hybrid of 3 desalting technologies to help offset electricity costs. In so doing, the disclosed design becomes a more reliable, ocean-friendly, energetically sustainable water supply for California's future. The unique aspects of the method include zero brine discharge, making it ocean-friendly, energy recovery, salt battery, and recovery of water and salt for sale.

### SUMMARY

The method comprises passing seawater through a membrane via the use of osmotic pressure applied by a piston or turbine; circulating the seawater desalination battery where there is a counter-current exchange; passing the seawater through a reverse osmotic system, creating a separation of potable water and heavy brine; evaporating said heavy brine from said seawater for recovery of remaining minerals, and returning the lower saline seawater back to the source.

### BRIEF DESCRIPTION OF THE DRAWINGS

FIG. 1 is a flowchart illustrating an ocean-friendly seawater desalination method.

FIG. 2 is a flowchart of the ocean desalination concept.

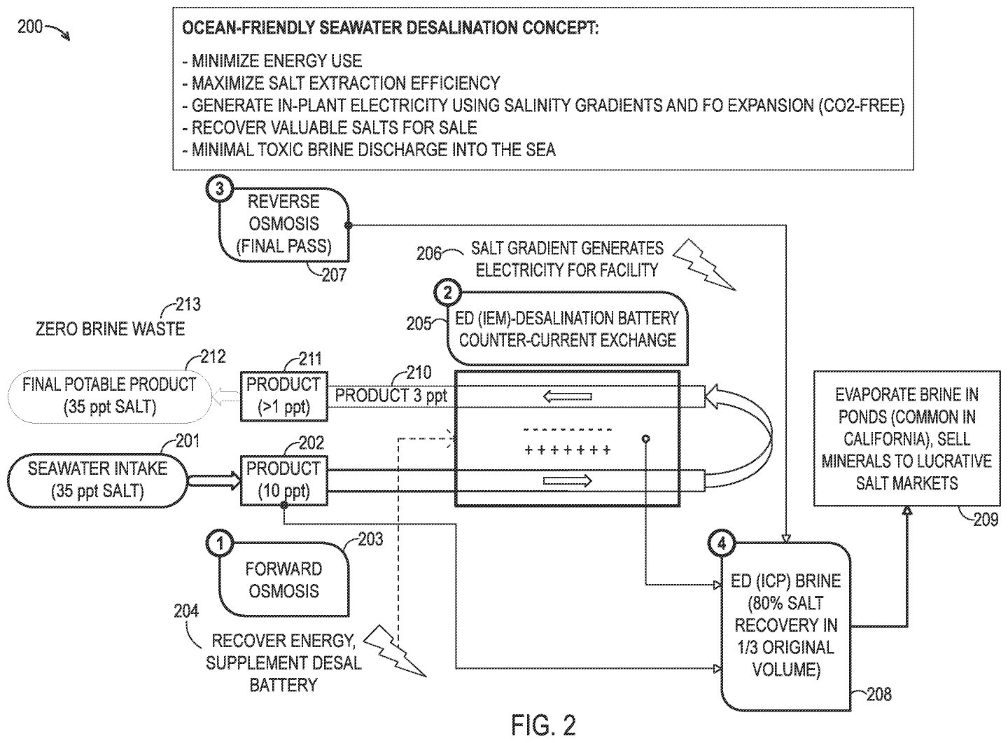

### DETAILED DESCRIPTION

The method will become better understood through a review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, various examples of the method are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The invention is a more efficient means to purify potable water from seawater while reducing the volume of brine waster such that it can be more easily processed for its valuable salts as a second product for sale. The substantial benefits of the embodiments include improving potable water recovery using the disclosed hybrid technology, which reduces seawater intake volumes by 50%, thereby causing less impingement/entrainment mortality to marine life. Better recovery also reduces brine discharge into the marine environment. Both of these are benefits that will make the disclosed design more “ocean-friendly” and attractive for permitting under California environmental laws. The design's ability to generate a more concentrated brine opens the door for producing additional salt products for sale. In addition, the design can recover electricity to augment the facility's energy demands. Both of these features will contribute to reducing energy costs over the lifetime of the plant.

A seawater intake system must be created and a method to mitigate marine fouling must be devised. Marine life that foul membranes and pipes can be treated with filters, UV light, a settling basin, and other techniques before the seawater enters the plant. These intakes will be site specific.

The design starts with a forward osmosis (FO) component placed at the front because the technology is less susceptible to marine fouling. Cath et al. offer a general review of how FO works (See Cath et al., Forward Osmosis: Principles, Applications, and Recent Developments, Journal of Membrane Science, 281, 70-87, 2006). Seawater will be pumped into a chamber with a water-permeable membrane separating a thermo-responsive draw solution of greater ionic strength on the other side. As freshwater is drawn across the membrane to equalize osmotic pressure, the draw volume expands. This expansion moves a piston and generates electricity, which is stored in a battery. The diluted draw is pumped to a second chamber, moving the piston again. The draw chamber is refilled to repeat the process. Meanwhile, the diluted draw solution is heated to about 50-60 deg. C to remove and recycle it for reuse. The less salty water left behind has a salinity of approximately 10 ppt

Meanwhile, the hypersaline brine will be pumped into a storage container for electrodialysis (ED) and salt recovery in the design's 4th component. Electricity from the battery charged during FO can be used to augment energy demands for a multi-stage stack of ion exchange membranes (IEM) that will pull dissolved salts through membranes and remove more salt. An analysis of this sort of electrodialysis process is found in Tado et al. (See Tado, et al., An Analysis of Ion Transport Process in Electrodialysis Desalination, Desalination, 378:60-66, 2016). The system can be set up along a series of stacks so that water flowing along the path creates a charge differential, which becomes a battery that further sustains the stack system. An assessment of the energy that can be obtained from such a system is described by Jalili et al. (See Jalili et al. Energy generation and Storage by Salinity Gradient Power: A model-based assessment, Journal of Energy Storage, Vol. 24, Article Number 100755, 2019). The brine would be pumped to the brine treatment component.

The third stage is a reverse osmosis (RO) component. Because salt levels will be well within RO's high-efficiency recovery range (˜80%), the volume of brine will be low. This brine would also be diverted to the storage container.

Combining the FO, ED, and RO brines in the storage container creates a salinity approaching 85 ppt in a volume less than one-third of the original starting volume. To reduce this volume further, a second ED component with a multi-stage ion concentration polarization (ICP) can be used to concentrate the salts by an additional 50%. This salt product is now more amenable to processing in solar drying ponds and then sold. Salt markets for battery production should be more lucrative in the future.

There are a number of 2-step hybrid designs that use FO and RO. To date, however, are no attempts to add in ED or designs that recover energy and salt as salable products. Moreover, none are ocean-friendly or capable of generating their own energy to offset electricity costs. Additionally, none of the multi-step designs recover both potable water and salt products.

A first embodiment may include an ocean-friendly seawater desalination method. A second embodiment may include passing seawater through a membrane via the use of osmotic pressure applied by a piston or turbine. A third embodiment may also include circulating the seawater desalination battery where there may be a counter-current exchange. A fourth embodiment may also include passing sea water through a reverse osmotic system, creating a separation of potable water and heavy brine. A fifth embodiment may also include evaporating the heavy brine from the sea water to recover the remaining minerals.

In the sixth embodiment, of the ocean-friendly seawater desalination method the removed heavy brine provides a liquid solution capable of capture, store, and eventually discharge of electrical energy. In the seventh embodiment, the ocean-friendly seawater desalination method provides salinity levels of remaining circulated sea water that may be less than the original level when returned to the original source of sea water.

In the preferred embodiment, the disclosed design would be co-located near a reverse osmosis wastewater recycling plant, or be constructed alongside one. There are several such facilities coming online along California's coast. Combining the disclosed seawater desalination design with a wastewater facility will minimize building and infrastructure costs. Wastewater is fast becoming a valuable source for RO purification and reinjection to recharge groundwater supplies. Combining the two water systems would be more efficient.

### Ocean-Friendly Seawater Desalination Method

With reference to the figures, OCEAN-FRIENDLY SEAWATER DESALINATION METHOD will now be described.

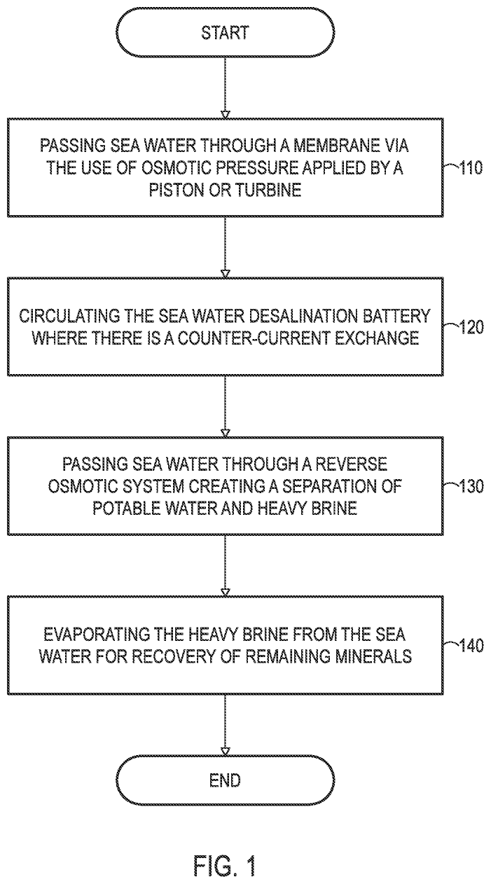

FIG. 1 is a flowchart that describes an ocean-friendly seawater desalination method according to some embodiments of the present disclosure. At 110, the ocean-friendly seawater desalination method may include passing seawater through a membrane via the use of osmotic pressure applied by a piston or turbine. At 120, the ocean-friendly seawater desalination method may include circulating the seawater desalination battery where there may be a counter-current exchange. At 130, the ocean-friendly seawater desalination method may include passing seawater through a reverse osmotic system, creating a separation of potable water and heavy brine. At 140, the ocean-friendly seawater desalination method may include evaporating the heavy brine from the seawater for recovery of remaining minerals. In some embodiments, where removed heavy brine may provide a liquid solution capable of capturing, storing, and eventually discharging electrical energy. In some embodiments, where salinity levels of remaining circulated sea water may be less than the original level when returned to the original source of seawater.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions, and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. An ocean-friendly method for desalination, comprising:
(a) providing a source of seawater,
(b) passing the seawater through a membrane using osmotic pressure,
(c) circulating the seawater using a desalination battery,
(d) passing the water through a reverse osmotic system,
(e) separating the desalinated water from a heavy brine.

2. The method of claim 1 where the osmatic pressure is provided by a piston or a turbine.

3. The method of claim 1, where the desalination battery has a counter-current exchange.

4. The method of claim 1 where the heavy brine is evaporated to recover the minerals.

5. The method of claim 1, where the heavy brine captures, stores, and discharges electrical energy.

6. The method of claim 1 where the salinity of remaining seawater is less than the original level of the seawater.

7. The method of claim 6 where the lower salinity seawater is returned to the source of seawater.

8. Where the separated desalinated water of claim 1 is potable.

9. An ocean-friendly method for desalination, comprising:
providing water from a wastewater recycling plant,
passing the water through a membrane using osmotic pressure,
circulating the water using a desalination battery,
passing the water through a reverse osmotic system,
separating the desalinated water from a heavy brine.

10. The method of claim 9 where the osmatic pressure is provided by a piston or a turbine.

11. The method of claim 9, where the desalination battery has a counter-current exchange.

12. The method of claim 9, where the heavy brine is evaporated to recover the minerals.

13. The method of claim 9, where the heavy brine captures, stores, and discharges electrical energy.

14. The method of claim 9, where the salinity of remaining water is less than the original level of the source water.

15. The method of claim 14, where the low salinity water is returned to the source.

16. Where desalinated water of claim 9 is potable.
